(19) United States
(12) Patent Application Publication
(10) Pub. No.: US 2013/0109003 A1
(43) Pub. Date: May 2, 2013

(54) METHOD FOR PROVIDING A STUDY PATTERN ANALYSIS SERVICE ON A NETWORK AND A SERVER USED THEREWITH

(71) Applicant: Sang-Gyu Lee, Seongnam-si (KR)

(72) Inventor: Sang-Gyu Lee, Seongnam-si (KR)

(21) Appl. No.: 13/704,809

(22) PCT Filed: Jun. 17, 2010
(86) PCT No.: PCT/KR2010/003900

§ 371 Date: Dec. 17, 2012

(51) Int. Cl. G09B 7/00

(52) U.S. Cl. CPC G09B 7/00
USPC 434/362

(57) ABSTRACT

A method is configured to provide a study pattern analysis service on a network, and a server used therewith. The server receives identification information from a smart pen used by a student to solve questions printed on a study material. The identification information, for each question is marked on locations where the questions are printed. The method and server generates study pattern information about the student based on the identification information received in the server. The study pattern analysis and study guidance for individual students using the study material are possible.

### CROSS-REFERENCE TO RELATED APPLICATION(S)

This application is a National Phase entry of PCT Application No. PCT/KR2010/003900, filed on Jun. 17, 2010 in the Korean Intellectual Property Office, the entire disclosure of which is incorporated herein by reference for all purposes.

### BACKGROUND

1. Field

The following description relates to a method to provide a study pattern analysis service on a network and a server used therewith. More particularly, a method is described to provide a study pattern analysis service on a network that is configured to analyze study patterns of individual students to guide the study of the individual students, and a server used therewith.

2. Description of Related Art

As education markets have diversified and grown, many students have chosen to conduct their studies from home using study materials that are periodically delivered to their homes. However, these study materials represent a problem in that the study materials are not suitable to all learning abilities. These study materials are not created to cater to a particular learning ability of the student.

As a result, some education providers employ teachers to visit individual students to assess the student's progress in their studies on a regular basis. There are, however, physical limitations in terms of the frequency the education providers can visit the student and the amount of time dedicated to each student. In addition, the costs associated with employing the teachers create a significant burden on the education providers and, ultimately, the students. Thus, the quality of the assessment made by the visiting teachers of each student faces some limitations.

### SUMMARY

This Summary is provided to introduce a selection of concepts in a simplified form that are further described below in the Detailed Description. This Summary is not intended to identify key features or essential features of the claimed subject matter, nor is it intended to be used as an aid in determining the scope of the claimed subject matter.

One of the many advantages of the configurations described in detailed below include a method to provide a study pattern analysis service on a network, which can analyze study patterns of individual students to guide the study of the individual students, and a server used therewith.

In accordance with an illustrative configuration, there is provided a method to provide a study pattern analysis service on a network. The method includes receiving identification information at a server from a smart pen used by a student solving questions printed on a study material. The identification information is printed on the study material and corresponds to each question. The method also includes generating study pattern information of the student based on the identification information received at the server.

The method further includes storing the study pattern information in the server. The method includes transmitting the study pattern information to a terminal of the student from the server.

In accordance with another illustrative configuration, there is provided a method to provide a study pattern analysis service on a network. The method includes receiving identification information and student information, at a server from a smart pen used by a student solving questions printed on a study material. The identification information is printed on the study material and corresponds to each question, and the student information comprises at least one of time information of when pressure is applied to the smart pen by the student, a pressure value applied to the smart pen by the student, humidity information of a hand of the student, pulse information of the student, and body temperature information of the student. The method also includes generating study pattern information of the student based on the identification information and the student information received at the server.

The method further includes storing the study pattern information in the server. The method includes transmitting the study pattern information to a terminal of the student from the server.

In accordance with an illustrative configuration, there is provided a server including a receiving module configured to receive identification information from a smart pen used by a student solving questions printed on a study material. The identification information is printed on the study material and corresponds to each question. The server also includes an analyzing module configured to generate study pattern information of the student based on the identification information.

The server further includes a storing module configured to store the study pattern information. The server includes a transmitting module configured to transmit the study pattern information to a terminal of the student.

In accordance with another illustrative configuration, there is provided a server including a receiver configured to receive identification information and student information from a smart pen used by a student solving questions printed on a study material. The identification information is printed on the study material and corresponds to each question, and the student information comprises at least one of time information of when pressure is applied to the smart pen by the student, a pressure value applied to the smart pen by the student, and humidity information of a hand of the student. The server also includes an analyzing module configured to generate study pattern information of the student based on the identification information and the student information.

The server further includes a storing module configured to store the study pattern information. The server includes a transmitting module configured to transmit the study pattern information to a terminal of the student.

Other features and aspects may be apparent from the following detailed description, the drawings, and the claims.

### BRIEF DESCRIPTION OF THE DRAWINGS

FIG. 1 is a schematic view showing a structure of a system to provide a study pattern analysis service on a network, according to an illustrative example;

FIG. 2 is a functional block view showing a structure of a server in a system to provide a study pattern analysis service on a network, according to an illustrative example; and

FIG. 3 is a flowchart showing a procedure of a method to provide a study pattern analysis service on a network, according an illustrative example.

Throughout the drawings and the detailed description, unless otherwise described, the same drawing reference numerals will be understood to refer to the same elements, features, and structures. The relative size and depiction of these elements may be exaggerated for clarity, illustration, and convenience.

### DETAILED DESCRIPTION

The following detailed description is provided to assist the reader in gaining a comprehensive understanding of the methods, apparatuses, and/or systems described herein. Accordingly, various changes, modifications, and equivalents of the systems, apparatuses and/or methods described herein will be suggested to those of ordinary skill in the art. Also, descriptions of well-known functions and constructions may be omitted for increased clarity and conciseness.

The terminology used herein is for the purpose of describing particular embodiments only and is not intended to be limiting of the present invention. As used herein, the singular forms “a,” “an” and “the” are intended to include the plural forms as well, unless the context clearly indicates otherwise. It will be further understood that the terms “comprises” and/or “comprising,” when used in this specification, specify the presence of stated features, integers, steps, operations, elements, and/or components, but do not preclude the presence or addition of one or more other features, integers, steps, operations, elements, components, and/or groups thereof.

Unless otherwise defined, all terms (including technical and scientific terms) used herein have the same meaning as commonly understood by one of ordinary skill in the art to which the present invention belongs. It will be further understood that terms, such as those defined in commonly used dictionaries, should be interpreted as having a meaning that is consistent with their meaning in the context of the relevant art and will not be interpreted in an idealized or overly formal sense unless expressly so defined herein.

Example embodiments of the present invention are described herein with reference to cross-sectional illustrations that are schematic illustrations of idealized embodiments (and intermediate structures) of the present invention. As such, variations from the shapes of the illustrations as a result, for example, of manufacturing techniques and/or tolerances, are to be expected. Thus, example embodiments of the present invention should not be construed as limited to the particular shapes of regions illustrated herein but are to include deviations in shapes that result, for example, from manufacturing. The regions illustrated in the figures are schematic in nature and their shapes are not intended to illustrate the actual shape of a region of a device and are not intended to limit the scope of the present invention.

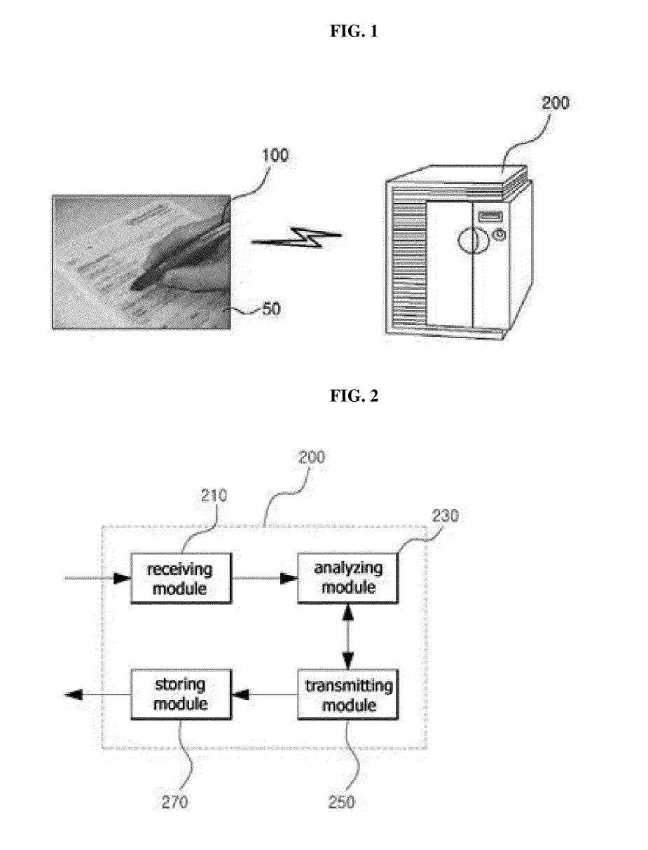

FIG. 1 is a schematic view showing a structure of a system to provide a study pattern analysis service on a network, according to an illustrative example. Referring to FIG. 1, the system to provide the study pattern analysis service on the network includes a study material 50, a smart pen 100, and a server 200.

The study material 50 is printed with questions for a student to solve. The study material 50 also includes identification information of each question marked on locations next to or near where the questions are printed. The identification information may include a dot code or a bar code, which may or may not be visible to the student.

The smart pen 100 is a ballpoint pen with an embedded computer and digital audio recorder having a network communication function with the server 200. When the student solves the questions on the study material 50 using the smart pen 100, the smart pen 100 reads or records the identification information of the question being solved from the study material 50 and transmits the identification information to the server 200. According to an illustrative example, the smart pen 100 is equipped with a time measurement unit to transmit time information to the server. The time information represents a reading time or recording time that the smart pen 100 recorded the identification information of the question.

In addition, pressure sensors may be provided in a writing portion and a grip portion of the smart pen 100, respectively. Thus, when the student uses the smart pen 100 to write down answers to the questions, the smart pen 100 transmits pressure values of the writing portion and the grip portion to the server 200 together with corresponding time information.

In addition, a humidity sensor is provided in the grip portion of the smart pen 100. The humidity sensor measures humidity from a hand of the student gripping the smart pen 100 and transmits measured humidity information to the server 200.

Further, a pulse sensor and a temperature sensor are provided in the grip part of the smart pen 100 to transmit pulse information and temperature information of the student to the server 200. The pulse sensor and the temperature sensor measure the pulse and the temperature, respectively, from the hand of the student gripping the smart pen 100.

In one illustrative example, the smart pen 100 is configured to obtain and transmit information associated with the student to the server 100. This student information obtained and transmitted may include one or more of the time information about the pressure, the pressure value, the humidity information, the pulse information, and the temperature information.

Referring to FIG. 1, the server 200 generates study pattern information associated with each student based on the corresponding student information and identification information transmitted from the smart pen 100, as the student solves the questions printed on the study material 50.

For instance, the server 200 stores information associated with the questions on the study material 50 and the identification information of each question printed on the study material 50. The information stored may also include information about a level of difficulty and a subject matter, context, or type of questions. Based on the student information received from the smart pen 100 and the information stored, the server 200 generates reporting information about the sequence of the questions the student solved and time consumed by the student for each question. The identification information and the student information would be associated with a particular student and would also include time information associated with the time at which the student and the identification information are received.

Therefore, the server 200 acquires information about the questions, that is, information about preferential questions primarily solved by the student and information about the time consumption according to the type of the questions. Based on the above information, the server 200 generates study pattern information suitable for individual students to analyze the study pattern of the individual students. In the alternative, the server 200 may also generate the study pattern information based on one or more of the additional information included in the student information, such as humidity information, pulse information, temperature information, and pressure values.

The server 200 accumulates and stores 200 the study pattern information so that the server 200 can produce a study pattern report for each student based on the study pattern information. In one example, the study pattern information may be generated in series for each student.

Then, the server 200 transmits the study pattern information or the study pattern report, which is made by accumulating the study pattern information, to the student's terminal, thereby enabling the student to receive the study pattern report as feedback to improve or correct his or her study pattern.

As previously explained, the student information, which is measured by the smart pen 100 and transmitted to the server 100, includes all or a part of the time information about the pressure, the pressure value, the humidity information of the student, the pulse information of the student, and information about the body temperature of the student.

In addition, in another configuration, the server 200 may generate the study pattern information of the student based on the identification information and student information transmitted from the smart pen 100 as the student solves the questions printed on the study material 50. That is, the server 200 may acquire the time information that represents the time it took the student to solve the question along with the corresponding identification number associated with the question based on the identification information received from the smart pen 100 of the student. The smart pen 100 may sequentially or simultaneously acquire the identification information including the time information about the pressure applied to the writing portion of the smart pen 100 when the student writes down answers and the time information representing the time that the identification information is received for the first time. In addition, the server 200 may also determine a state of tension of the student when the student solves the question based on the identification information received, sequentially or simultaneously, from the smart pen 100, the pressure value applied to the grip portion of the smart pen 100, the humidity information of the hand of the student, the pulse information or the body temperature information.

In one example, if the pressure value, the humidity information, the pulse information, and the body temperature information are received with student identification information are higher than an average pressure value and an average humidity information previously measured and stored for a particular student by a predetermined ratio, the server 200 determines that the student feels tension more than ordinary times when the student solves the question corresponding to the identification information.

Furthermore, the server 200 analyzes the time information that represents the time taken by the student to solve the question corresponding to the identification number. If the analysis result represents that the time consumed by the student to solve the question is longer than the average time consumed for each question by a predetermined ratio, the server 200 determines that the particular question is too hard for the student. That is, the server 200 may acquire information about an amount of tension from the student and the level of difficulty according to the particular question. The server 200 would add this information to the study pattern report for each student.

FIG. 2 is a functional block view showing a structure of the server in the system to provide the study pattern analysis service on the network, according to an illustrative example. Referring to FIG. 2, the server 200 includes a receiving module 210, an analyzing module 230, a storing module 250, and a transmitting module 270.

The receiving module 210 is configured to receive the identification information and the student information transmitted from the smart pen 100. The analyzing module 230 is configured to generate the study pattern information of the student and the study pattern report for each student based on the identification information and the student information.

In addition, the storing module 250 is configured to store the information about the level of difficulty and the type of the questions as information corresponding to the identification information for each question. In addition, the storing module 250 is configured to store information about preceding study contents related to the type of the questions and the question pool in the study material 50. The question pool may include questions related to the preceding study contents related to a portion of the study material 50.

In addition, the storing module 250 is configured to store the identification information received at the receiving module 210 with the time information, which is indicative of the time that the student information is reduced. Also, the storing module 250 is configured to store the study pattern information and the study pattern report generated by the analyzing module 230.

Further, the transmitting module 270 is configured to periodically transmit the study pattern information and the study pattern report generated by the analyzing module 230 to the student's terminal.

The modules described and illustrated with respect to FIG. 2 may be implemented using hardware components. For example, controllers and/or processing devices. A module or processing device may be implemented using one or more general-purpose or special purpose computers, such as, for example, a processor, a controller and an arithmetic logic unit, a digital signal processor, a microcomputer, a field programmable array, a programmable logic unit, a microprocessor or any other device capable of responding to and executing instructions in a defined manner. The processing device may run an operating system (OS) and one or more software applications that run on the OS. The processing device also may access, store, manipulate, process, and create data in response to execution of the software. For purpose of simplicity, the description of a processing device is used as singular; however, one skilled in the art will appreciated that a processing device may include multiple processing elements and multiple types of processing elements. For example, a processing device may include multiple processors or a processor and a controller. In addition, different processing configurations are possible, such a parallel processors.

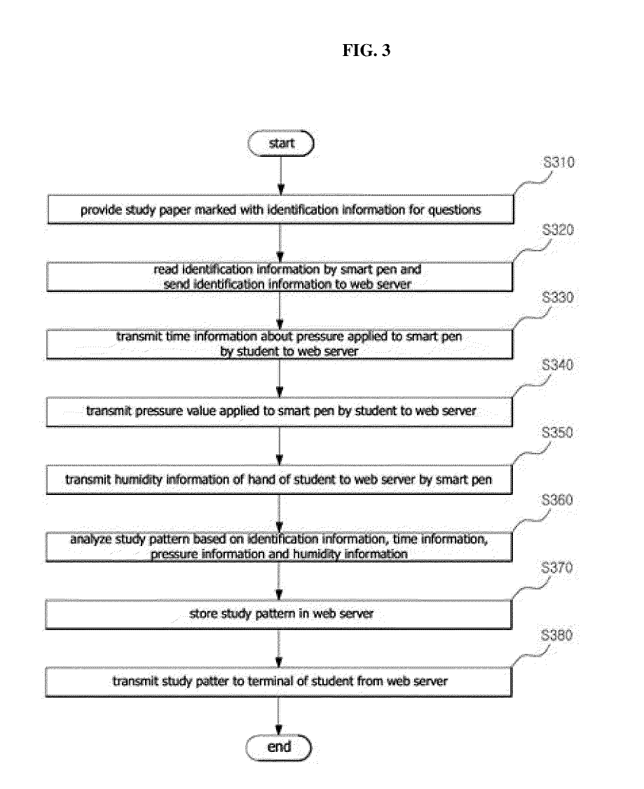

FIG. 3 is a flowchart showing a procedure of a method for providing the study pattern analysis service on the network, according to an illustrative example. Hereinafter, the procedure of the method for providing the study pattern analysis service on the network, according to an illustrative example, will be described with reference to FIGS. 1 to 3.

At S310, the method is configured to prepare the study material 50 to be marked or associated with the identification information for each printed question. That is, the study material 50 used may be printed with questions to be solved by the student along with corresponding identification information of each question placed at positions where the questions are printed. According to an example, the identification information may include a dot code or a bar code which is not visible to the student.

The student having the membership for the study pattern analysis service of the present invention periodically receives a series of study materials 50 from the administrator of the study pattern analysis service. In addition, the student solves the questions in the study material 50 by using the smart pen 100 received from the administrator when the student joins the membership for the service. At S320, the method configures the smart pen 100 to read the identification information for the question being solved by the student and to transmit the identification information to the server 200.

According to an illustrative example, at S330, when the identification information is transmitted to the server 200, the method transmits the time information that a particular amount of pressure is applied to the smart pen 100 by the student. At S340, the method is configured to transmit the value of the pressure applied to the smart pen 100 by the student. At S350, the method is configured to transmit at least one of the humidity information of the hand of the student, the pulse information of the student and the body temperature information of the student.

Thus, the receiving module 210 of the server 200 may receive from the smart pen 100 at least one of the identification information, the time information, the pressure value, the humidity information, the pulse information of the student, and the body temperature information of the student.

According an illustrative example, the smart pen 100 may transmit the identification information and the student information to the server 200 in real time. In the alternative, the smart pen 100 may collectively transmit the identification information and the student information to the server 200 after storing the identification information and the student information in the storing module 250 provided in the smart pen 100, while the student is solving the questions. In this instance, the storing module 250 provided in the smart pen 100 may store the time information for the identification information and the student information.

Further, according to an illustrative example, the smart pen 100 may directly transmit the identification information and the student information stored in the storing module 250 of the smart pen 100 to the server 200. In the alternative, the smart pen 100 may transmit the information to the server 200 using a communication terminal after shifting the information to the student's terminal through a USB port provided in the smart pen 100.

In detail, the student's communication terminal may include, but it is not limited to, a personal computer (PC) and the student may upload the identification information and the student information stored in the PC to the server 200 by accessing the homepage of the server 200 using the PC.

At S360, the method is configured to store the identification information and the student information received at the receiving module 210 in the storing module 250. Also, the method is further configured to generate at the analyzing module the study pattern information of the student based on the identification information and the student information to analyze the study pattern of the student.

In addition, because the storage module 250 stores the information about the level of difficulty and the type of the questions as the information corresponding to the identification information of each question, the method may also configure the analyzing module 230 to generate information about the sequence of the questions primarily solved by the student and the time taken by the student to complete each question according to the identification information and the time information representing the time at which the identification information is received. Therefore, the information about the type of the questions preferred by the student and the time taken by the student to complete the questions according to the type of the questions can be acquired.

In addition, the method may also configure the analyzing module 230 to generate the study pattern information of the student based on the student information and the identification information. That is, the analyzing module 230 of the server 200 may acquire the time information that represents the time taken by the student to solve the question corresponding to the identification number based on the identification information, the time information about the pressure applied to the writing portion of the smart pen 100 when the student writes down answers, and the time information representing the time that the identification information is received for the first time.

In addition, the method may also configure the analyzing module 230 to acquire the state of tension of the student when the student solves the question corresponding to the identification number based on the identification information, the pressure value applied to the grip portion of the smart pen 100, or the humidity information of the student's hand.

Furthermore, the method configures the analyzing module 230 to analyze the time information that represents the time taken by the student to solve the question corresponding to the identification number. If the analysis result represents that the time consumed by the student to solve the question is longer than the average time consumed for each question by a predetermined ratio, the method configures the analyzing module 230 to finally determine that the type of the question is too hard for the student.

That is, the method configures the analyzing module 230 to acquire information about the type of questions the student prefers, the time taken to solve the question according to the type of the questions, the state of tension of the student according to the type of the questions. and the level of difficulty according to the type of the question. The method can then generate the study pattern report for each student based on the analyzed study pattern.

According to an illustrative example, the method configures the analyzing module 230 to add a advice comment corresponding to the study pattern to the study pattern report based on the analyzed study pattern of the student. For instance, the advice comment may provide information advising the student to study the type of the questions determined as having a higher level of difficulty or advising the student to perform the preceding study required for solving the type of the questions having the higher level of difficulty.

In addition, the method may configure the analyzing module 230 to determine the contents of the study material 50 for the student based on the analyzed study pattern in order to prepare the study material 50 suitable for the student. For instance, the contents of the study material 50 may include the questions determined as having a higher level of difficulty and the questions related to the preceding study required for solving the questions having the high level of difficulty.

At S370, the method stores the study pattern of the student and the study pattern report of the student analyzed by the analyzing module 230 in the storage module 250 corresponding to the individual students. At S380, the transmitting module 270 of the server 200 transmits the analyzed study pattern and the study pattern report to the terminal of the student.

As a result of the configuration describe in the various examples discussed above with regards to FIGS. 1-3, the student can improve or correct the study pattern by taking the study pattern information and the study pattern report into consideration.

Program instructions to perform a method described herein, or one or more operations thereof, may be recorded, stored, or fixed in one or more computer-readable storage media. The program instructions may be implemented by a computer. For example, the computer may cause a processor to execute the program instructions. The media may include, alone or in combination with the program instructions, data files, data structures, and the like. Examples of computer-readable media include magnetic media, such as hard disks, floppy disks, and magnetic tape; optical media such as CD ROM disks and DVDs; magneto-optical media, such as optical disks; and hardware devices that are specially configured to store and perform program instructions, such as read-only memory (ROM), random access memory (RAM), flash memory, and the like. Examples of program instructions include machine code, such as produced by a compiler, and files containing higher level code that may be executed by the computer using an interpreter. The program instructions, that is, software, may be distributed over network coupled computer systems so that the software is stored and executed in a distributed fashion. For example, the software and data may be stored by one or more computer readable recording mediums. Also, functional programs, codes, and code segments for accomplishing the example embodiments disclosed herein can be easily construed by programmers skilled in the art to which the embodiments pertain based on and using the flow diagrams and block diagrams of the figures and their corresponding descriptions as provided herein.

As a non-exhaustive illustration only, the student's terminal described herein may refer to mobile devices such as a cellular phone, a personal digital assistant (PDA), a digital camera, a portable game console, and an MP3 player, a portable/personal multimedia player (PMP), a handheld e-book, a portable lab-top PC, a global positioning system (GPS) navigation, a tablet, a sensor, and devices such as a desktop PC, a high definition television (HDTV), an optical disc player, and the like that are capable of wireless communication or network communication consistent with that which is disclosed herein.

A number of examples have been described above. Nevertheless, it will be understood that various modifications may be made. For example, suitable results may be achieved if the described techniques are performed in a different order and/or if components in a described system, architecture, device, or circuit are combined in a different manner and/or replaced or supplemented by other components or their equivalents. Accordingly, other implementations are within the scope of the following claims.

1. A method to provide a study pattern analysis service on a network, the method comprising:
receiving identification information at a server from a smart pen used by a student solving questions printed on a study material, wherein the identification information is printed on the study material and corresponds to each question; and
generating study pattern information of the student based on the identification information received at the server.

2. A method to provide a study pattern analysis service on a network, the method comprising:
receiving identification information and student information, at a server, from a smart pen used by a student solving questions printed on a study material, wherein the identification information is printed on the study material and corresponds to each question, and the student information comprises at least one of time information of when pressure is applied to the smart pen by the student, a pressure value applied to the smart pen by the student, humidity information of a hand of the student, pulse information of the student, and body temperature information of the student; and
generating study pattern information of the student based on the identification information and the student information received in at the server.

3. The method of claim 1, further comprising:
storing the study pattern information in the server.

4. The method of claim 1, further comprising:
transmitting the study pattern information to a terminal of the student from the server.

5. A server, comprising:
a receiving module configured to receive identification information, from a smart pen used by a student solving questions printed on a study material, wherein the identification information is printed on the study material and corresponds to each question; and
an analyzing module configured to generate study pattern information of the student based on the identification information.

6. A server comprising:
a receiver configured to receive identification information and student information from a smart pen used by a student solving questions printed on a study material, wherein the identification information is printed on the study material and corresponds to each question, and the student information comprises at least one of time information of when pressure is applied to the smart pen by the student, a pressure value applied to the smart pen by the student, and humidity information of a hand of the student; and
an analyzing module configured to generate study pattern information of the student based on the identification information and the student information.

7. The server of claim 6, further comprising:
a storing module configured to store the study pattern information.

8. The server of claim 6, further comprising:
a transmitting module configured to transmit the study pattern information to a terminal of the student.

9. The method of claim 1, further comprising:
storing the study pattern information in the server.

10. The method of claim 1, further comprising:
transmitting the study pattern information to a terminal of the student from the server.

11. The server of claim 7, further comprising:
a storing module configured to store the study pattern information.

12. The server of claim 7, further comprising:
a transmitting module configured to transmit the study pattern information to a terminal of the student.
